(19) United States
(12) Patent Application Publication
(10) Pub. No.: US 2014/0372038 A1
(43) Pub. Date: Dec. 18, 2014

(54) METHOD FOR GENERATING AND DISPLAYING A NOWCAST IN SELECTABLE TIME INCREMENTS

(71) Applicant: SKY MOTION RESEARCH, ULC, Montreal (CA)

(72) Inventor: André LeBlanc, Mont-Royal (CA)

(73) Assignee: SKY MOTION RESEARCH, ULC, Montreal (CA)

(21) Appl. No.: 13/947,331

(22) Filed: Jul. 22, 2013

Related U.S. Application Data
(60) Provisional application No. 61/835,626, filed on Jun. 16, 2013.
(60) Provisional application No. 61/836,713, filed on Jun. 19, 2013.
(60) Provisional application No. 61/839,675, filed on Jun. 26, 2013.

(51) Int. Cl. G01W 1/10

(52) U.S. Cl. CPC G01W 1/10
USPC 702/3

(57) ABSTRACT

The present document describes a method for generating and displaying a succession of short-term weather forecasts, also called nowcasts, in selectable time increments. A system for preparing nowcasts, called nowcaster, is used for preparing short-term forecasted weather values with a default time increment between each one of them. The method receives a chosen time increment from a user and the prepared forecasted weather values. The method comprises an aggregator that re-packages the forecasted weather values in the chosen time increments. A succession of short-term weather forecasts, which is a collection of forecasted weather values at the chosen time increment, is then outputted.

### CROSS-REFERENCE TO RELATED APPLICATIONS

This application is related to co-owned and co-invented U.S. patent application Ser. No. 13/856,923 filed on Apr. 4, 2013, provisional patent application No. 61/835,626 filed on Jun. 16, 2013, provisional patent application No. 61/836,713 filed on Jun. 19, 2013, U.S. patent application Ser. No. 13/922,800 filed on Jun. 20, 2013 and provisional patent application No. 61/839,675 filed on Jun. 26, 2013, the specifications of which are hereby incorporated by reference.

### BACKGROUND

(a) Field

The subject matter disclosed generally relates to methods for producing weather forecasts. More specifically, the subject matter relates to software applications for producing weather forecasts.

(b) Related Prior Art

Conventional weather forecasting systems provide weather predictions twelve hours to a few days from the present time. If one needs a short term forecast or a forecast with a fine time scale, the best information available usually is an hourly forecast for the day.

Conventional weather forecasts are average forecasts for the area for which they are generated. Thus, a forecast may be inaccurate for a precise location within this area, and even the present weather displayed for an area may differ from the actual weather for a precise location within this area.

Moreover, conventional weather forecasts are displayed at a time scale that is too coarse to allow a user to know when a weather event takes place in a precise location and time. Even for hourly conventional weather forecasts, it is impossible for the user to know if the forecasted weather event lasts one hour or one minute and, for the latter, at what time it takes place exactly within the hour.

There is a need in the market for the generation and display of short term weather forecasts at different time scales.

### SUMMARY

The present embodiments describe such a method.

According to an embodiment, there is provided a computer implemented method for outputting a chronological succession of weather forecasts starting at a given time, over a given period, and for a given territory, the method comprising: receiving forecasted weather values prepared by a weather value forecaster, the forecasted weather values starting at the given time and for subsequent times separated by a default time increment; receiving a choice of a time increment from a user, the chosen time increment defining a succession of specific times starting at the given time and for subsequent times separated by the chosen time increment, the chosen time increment being smaller than 1 hour; for each choice of a time increment, using the forecasted weather values at the default time increment for generating a new succession of weather forecasts for time intervals between the specific times; and outputting the succession of weather forecasts for the time intervals between the specific times.

According to an embodiment, receiving the forecasted weather values comprises receiving forecasted weather values which comprise at least one of a precipitation rate, a precipitation type, a precipitation probability, a temperature, a pressure, a relative humidity, a wind velocity, a wind direction, a value relative to a lightning, a value relative to hail, and a value relative to a microburst.

According to an embodiment, generating the succession of weather forecasts comprises using at least one of a precipitation rate, a precipitation type, a precipitation probability, a temperature, a pressure, a relative humidity, a wind velocity, a wind direction, a value relative to a lightning, a value relative to hail, and a value relative to a microburst among the forecasted weather values.

According to an embodiment, generating the succession of weather forecasts for the time intervals between the specific times comprises selecting among the forecasted weather values prepared at the default time increment at least one of the forecasted weather values prepared for each specific time.

According to another embodiment, generating the succession of weather forecasts for the time intervals between the specific times comprises averaging weather values prepared for times that are within a time range which includes each specific time and selected among the forecasted weather values prepared at the default time increment.

According to an embodiment, outputting the succession of weather forecasts comprises presenting the succession of weather forecasts to the user.

According to an embodiment, outputting the succession of weather forecasts comprises outputting the succession of weather forecasts over a given period smaller than 6 hours.

According to an embodiment, receiving a choice of a time increment comprises receiving a time increment saved from a previous use.

According to an embodiment, generating the succession of weather forecasts at the chosen time increment comprises generating the succession of weather forecasts at a chosen time increment of 1 minute, 5 minutes, 15 minutes or 30 minutes.

According to an embodiment, receiving a choice of a time increment comprises receiving a choice of a time increment which is variable over the given period.

According to an embodiment, generating the succession of weather forecasts starting at the given time comprises generating the succession of weather forecasts starting at a current time.

According to an embodiment, outputting a succession of weather forecasts for a given territory comprises outputting a succession of weather forecasts for a very small region defined as having a resolution ranging between 5 meters and 1,000 meters.

According to an embodiment, outputting a succession of weather forecasts for a very small region comprises outputting a succession of weather forecasts for a current location of the user.

According to an embodiment, outputting a succession of weather forecasts for a current location of the user comprises outputting a succession of weather forecasts for a current location which is determined through a computing device which is enabled for localization by a communication network or through a GPS navigation device.

According to an embodiment, receiving a choice of a time increment from a user comprises receiving any real number specified by the user.

According to an embodiment, receiving a choice of a time increment from a user comprises receiving the chosen time increment which is greater than or equal to the default time increment.

In another aspect, there is provided a system for outputting a chronological succession of weather forecasts starting at a given time, over a given period, and for a given territory, the system comprising: an input for receiving forecasted weather values prepared by a weather value forecaster, the forecasted weather values starting at the given time and for subsequent times separated by a default time increment; an input for receiving a choice of a time increment from a user, the chosen time increment defining a succession of specific times starting at the given time and for subsequent times separated by the chosen time increment, the chosen time increment being smaller than 1 hour; a weather forecast generator for generating, for each choice of a time increment, a new succession of weather forecasts for time intervals between the specific times using the forecasted weather values; and an output for outputting the succession of weather forecasts for the time intervals between the specific times.

### DEFINITIONS

In the present specification, the following terms are meant to be defined as indicated below:

Nowcasting: The term nowcasting is a contraction of “now” and “forecasting”; it refers to the sets of techniques devised to make short term forecasts, typically in the 0 to 12 hour range.

A nowcaster or system for preparing nowcasts is a weather forecasting device which prepares very short term (e.g., 1 min., 5 mins., 15 mins., 30 mins., etc.) forecasts for a very small region on Earth (resolution of 5 meters, 10 meters, 50 meters, 100 meters, 500 meters, 1,000 meters, etc.). The nowcaster comprises a weather values forecaster for preparing forecasted weather values and a weather forecast generator for generating weather forecasts by selecting forecasted weather values among the forecasted weather values that have been prepared.

A weather value a weather related quantity or attribute of any sort such as a precipitation rate, a precipitation type, a precipitation probability, a temperature, a pressure, a relative humidity, a wind velocity, a wind direction, a value relative to a lightning, a value relative to hail, a value relative to a microburst, an accumulation, a cloud cover, etc.

A forecasted weather value is a weather value that is predicted by the nowcaster. The forecasted weather value relates to a time or to a time interval.

A weather forecast is a set of one or more forecasted weather values that are displayable to users. The weather forecast relates to a time or to a time interval.

A user is a person to whom or a machine to which a weather forecast is forwarded.

A weather-related event is, for example, at least one of hail, a wind gust, lightning, a temperature change, etc.

Precipitation type (PType): indicates the type of precipitation. Examples of precipitation types include, but are not limited to, rain, snow, hail, freezing rain, ice pellets, ice crystals.

Precipitation rate (PRate): indicates the precipitation intensity. Examples of precipitation rate values include, but are not limited to, no (i.e., none), light, moderate, heavy, extreme. In an embodiment, the precipitation rate can also be expressed as a range of values such as: none to light, light to moderate, moderate to heavy, or any combination of the above.

Precipitation probability: indicates the probability that precipitation might occur. Examples of precipitation probability values include, but are not limited to, no, unlikely, slight chance of, chance of, likely, very likely, certain.

In an embodiment, the precipitation probability can also be expressed as a range of values such as: none to light, light to moderate, moderate to heavy. Precipitation probability may also be expressed in terms of percentages; e.g., 0%, 25%, 50%, 75%, 100%; or ranges of percentages; e.g., 0% to 25%, 25% to 50%, 50% to 75%, 75% to 100%. In an embodiment, the precipitation probability may be taken from a probability distribution.

Precipitation type and precipitation rate categories (PTypeRate): a PTypeRate category is combination of precipitation type and precipitation rate to which may be associated a probability of occurrence for a given period to indicate the possibility of receiving a certain type of precipitation at a certain rate.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. The term “comprising” and “including” should be interpreted to mean: including but not limited to.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1A is a block diagram of a method for generating and displaying a nowcast in selectable time increments in accordance with an embodiment;

FIG. 1B is a block diagram of a method for generating and displaying a nowcast in selectable time increments in accordance with another embodiment;

FIG. 2A is a block diagram of a suitable nowcaster for implementing the embodiments;

FIG. 2B is a more detailed block diagram of a suitable nowcaster for implementing the embodiments;

FIG. 3 is an example of a network environment in which the embodiments may be practiced;

FIG. 4 is an exemplary diagram illustrating a suitable computing operating environment in which embodiments of the invention may be practiced;

FIG. 5 is a screenshot of a user interface, on which the embodiments of the method may be practiced, illustrating a weather forecast displayed with a one-minute time increment;

FIG. 6 is a screenshot of a user interface, on which the embodiments of the method may be practiced, illustrating a weather forecast displayed with a five-minute time increment.

It will be noted that throughout the appended drawings, like features are identified by like reference numerals.

### DETAILED DESCRIPTION

The embodiments will now be described more fully hereinafter with reference to the accompanying drawings, which form a part hereof, and which show, by way of illustration, specific embodiments by which the embodiments may be practiced. The embodiments are also described so that the disclosure conveys the scope of the invention to those skilled in the art. The embodiments may, however, be embodied in many different forms and should not be construed as limited to the embodiments set forth herein.

Among other things, the present embodiments may be embodied as methods or devices. Accordingly, the embodiments may take the form of an entirely hardware embodiment, an entirely software embodiment, an embodiment combining software and hardware aspects, etc. Furthermore, although the embodiments are described with reference to a portable or handheld device, they may also be implemented on desktops, laptop computers, tablet devices or any computing device having sufficient computing resources to implement the embodiments.

Briefly stated, the present embodiments describe a computer implemented method for generating and displaying a nowcast in selectable time increments. The user of the method selects a time increment and the weather forecast is outputted following the selected time increment. The weather forecast is generated by a short-term weather forecaster known as system for preparing nowcasts or nowcaster, described more thoroughly hereinbelow.

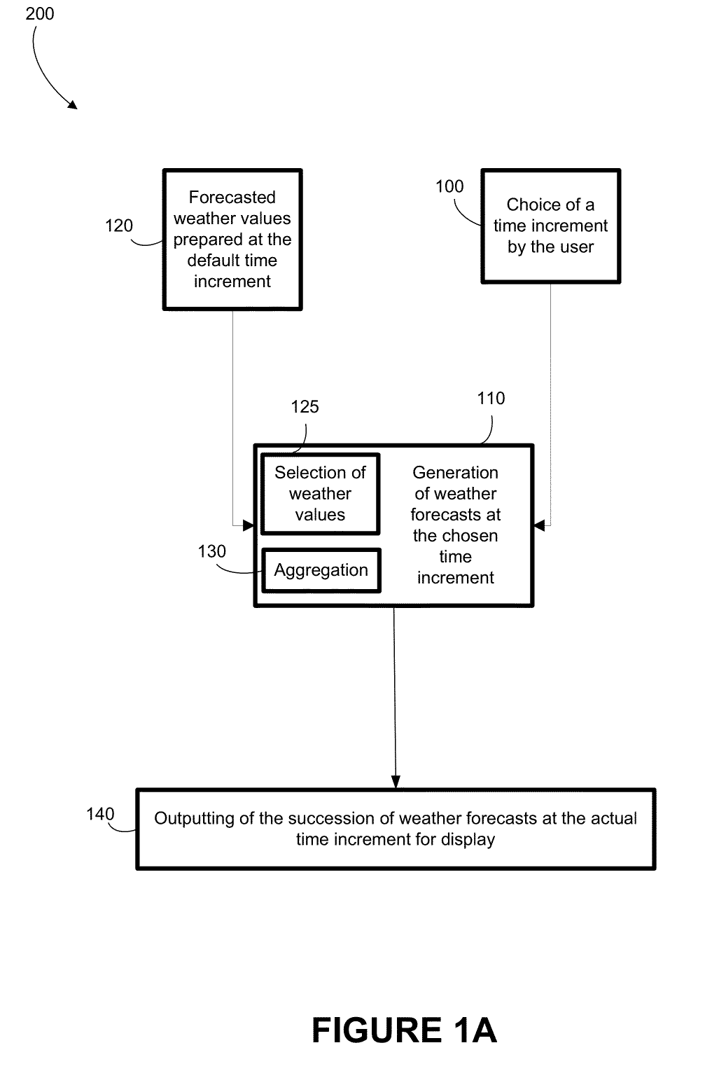

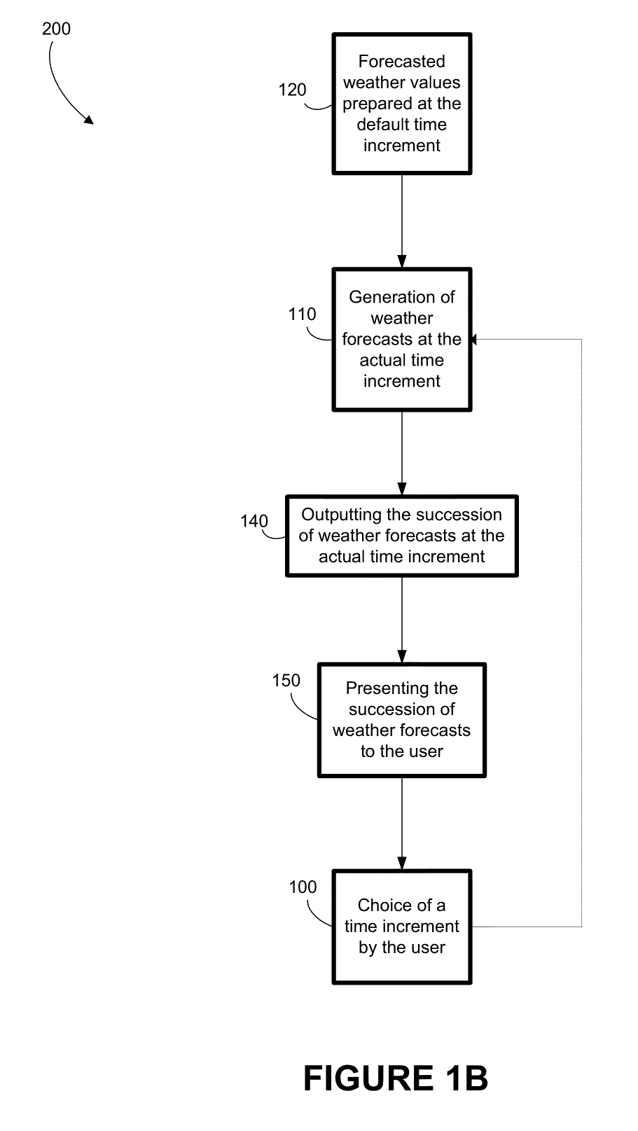

FIG. 1A is a block diagram of a method for generating and displaying a nowcast in selectable time increments in accordance with an embodiment. The method shown in FIG. 1 is implemented within the nowcaster 200. Forecasted weather values 120 are prepared within the nowcaster 200. The forecasted weather values 120 start from a given time are prepared over a given period at the default time increment for a given territory. In an embodiment, the given time is a current time. In an embodiment, the default time increment is the finest time increment, for example one minute. In another embodiment, it is possible to have a chosen time increment 100 which is smaller than the default time increment, in which case an interpolation is required.

According to the embodiment, the forecasted weather values may be prepared within the method, but they may also be prepared by a weather value forecaster that is not a part of the method, in which case the method described herein comprises receiving the forecasted weather values.

FIG. 1A further illustrates the user choosing a time increment 100. The choice is made through a user interface. The chosen time increment 100 is most often (but not necessarily) equal to or greater than the default characterizing the forecasted weather values 120.

According to an embodiment, the time increment may be memorized, for later retrieving the memorized time increment instead of prompting the user for a choice, thus allowing using a time increment saved from a previous use of the method.

According to an embodiment, the chosen time increment 100 may include a plurality of chosen time increments, allowing the generation 110 of weather forecasts to be done with a time increment that is variable across the given period over which the weather forecasts are generated. For example, the weather forecasts may be generated and outputted for a time increment of 1 minute for the first 5 minutes, then changing to a time increment of 5 minutes during the first hour, then changing to a time increment of 30 minutes for the next hours.

Once the forecasted weather values 120 and the chosen time increment 100 are both known, the method is ready for the generation 110 of weather forecasts at the chosen time increment. According to an embodiment, the generation 110 of weather forecasts may comprise two steps, as illustrated by FIG. 1A. Since forecasted weather values are not all relevant for a user, a selection 125 of weather values is performed to keep only relevant values for the weather forecasts eventually outputted by the method. The aggregation 130 may then take place.

The aggregation 130 is the part of the method that transforms the list of relevant forecasted weather values resulting from selection 125 generated for the default time increment into a list of forecasted weather values 120 with the chosen time increment 100, which is coarser than the default time increment; i.e., the chosen time increment 100 is greater than or equal to the default time increment.

According to an embodiment, the aggregation 130 is precipitation-oriented, meaning that when the aggregation 130 takes place, it verifies if a precipitation is likely to take place within the chosen time increment 100, and if the answer is yes, then the precipitation type and rate that might happen during the chosen time increment 100 will be outputted. For example, in this embodiment, if the default time increment for the forecasted weather values 120 is one minute, and if the user chooses a five-minute time increment 100, the aggregation 130 will check the five forecasted weather values 120 that have been generated within that time frame and check for a forecasted precipitation. If four forecasted weather values 120 are “no precipitation” and one is “risk of light rain” for example, and then the aggregation 130 will allow the output 140 of a risk of light rain.

In other words, the chosen time increment defines a succession of times, called specific times, which start at the given time (which may be or not the current time) and for subsequent times separated by the chosen time increment 100. The succession of specific times may be used to separate time intervals for which the succession of weather forecasts is generated. The method comprises selecting among the forecasted weather values prepared at the default time increment at least one of the forecasted weather values prepared for each specific time.

According to another embodiment, the aggregation 130 may comprise averaging the forecasted weather values 120 that are within the chosen time increment 100. For example, in this embodiment, if the default time increment for the forecasted weather values 120 is one minute, and if the user chooses a five-minute time increment 100, the aggregation 130 will comprise averaging the five forecasted weather values 120 of the same type (e.g. five temperature values, or five pressure values, or five PTypeRate values, etc.) that have been generated within that time frame and that mean will be used for the display of the chronological succession of weather forecasts. Averaging weather values may comprise computing an arithmetic mean or a geometric mean. It would be possible to avoid using all the weather values for averaging.

In other words, this embodiment may still use the specific times and time intervals separated by the specific times as defined for the previous embodiment described hereinabove. The succession of weather forecasts is generated for the time intervals between these specific times. In this embodiment, for each specific time, the method comprises selecting among the forecasted weather values prepared at the default time increment for times that are within a time range which includes each specific time, and then averaging these weather values to generate a weather forecast for this time interval. During display, this weather forecast may be associated to the closest specific time instead of the time interval, for the convenience of the user.

In other embodiments, the aggregation 130 may comprise other algorithms or selection rules to determine how the forecasted weather values 120 generated for the fine default time increment are aggregated to the coarser chosen time increment 100.

The outputting 140 may comprise displaying the succession of weather forecast relatively to a given period. According to an embodiment, this given period may change according to the chosen time increment 100.

The output 140 may be updated at a given frequency to allow the user to know the most recent succession of weather forecasts.

According to other embodiments, the outputting 140 may comprise saving the succession of weather forecasts, or sending it to another computer.

According to an embodiment, the chosen time increment 100 may vary across the given period over which the succession of weather forecasts is outputted.

FIG. 1B illustrates a different embodiment on which the method is embedded. The difference with the embodiment presented in FIG. 1A lies in the fact that the choice of a time increment 100 is not done at the beginning of the method. In the present embodiment, once the forecasted weather values 120 are known, the default time increment of the weather values is considered for the generation 110 of weather forecasts at the default time increment. The outputting 140 of the succession of weather forecasts occurs for presenting 150 to the user. Then the user may choose the time increment 100. This choice brings the method back to the generation 110 of weather forecasts at the actual time increment, followed by the outputting 140 and the presenting 150 of the succession of weather forecasts at the actual time increment, until the user chooses a new time increment 100.

### Nowcaster

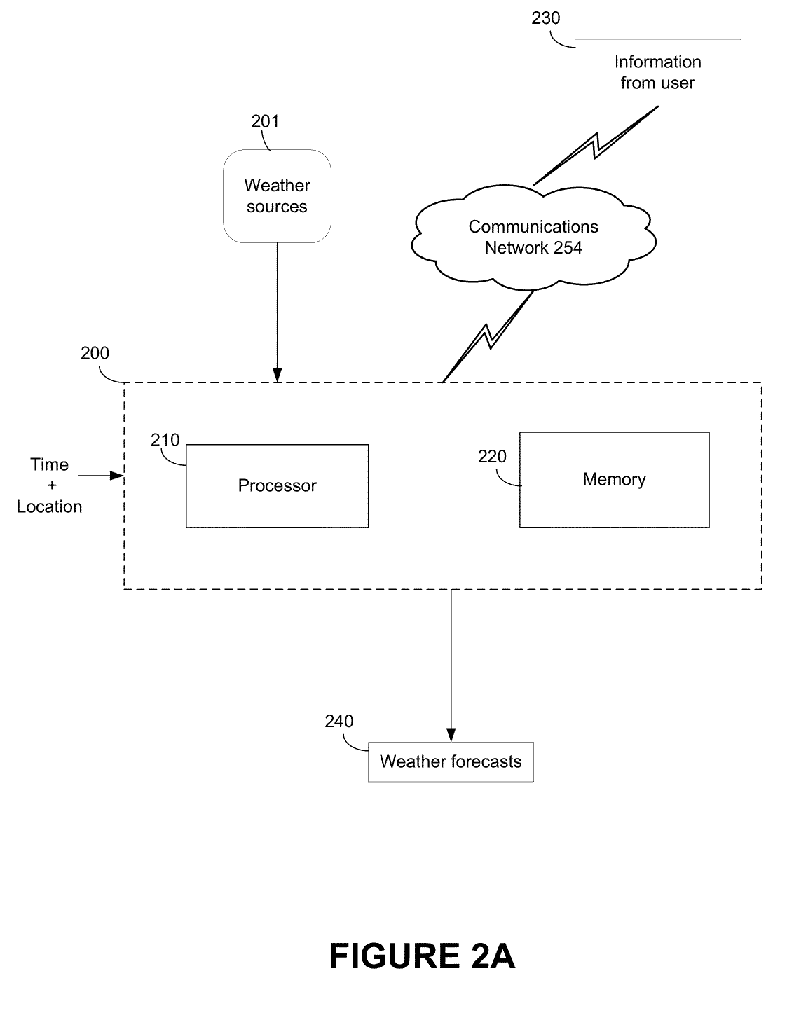

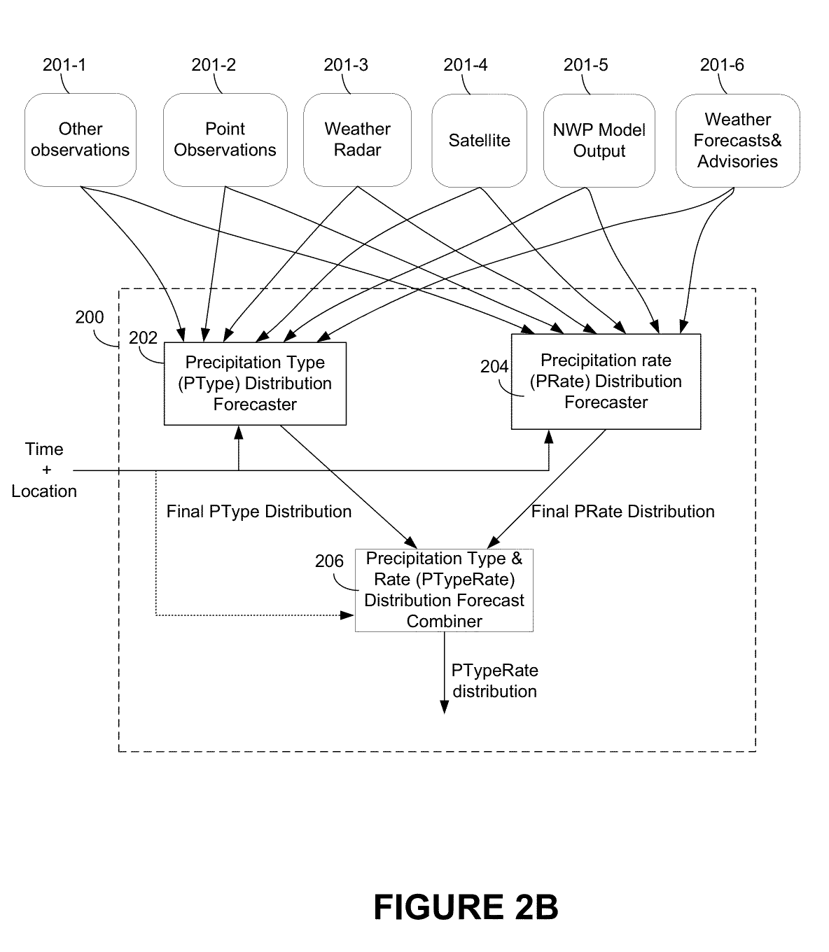

FIGS. 2A and 2B are block diagrams of a suitable nowcaster 200 such as that described in co-owned and co-invented U.S. patent application Ser. No. 13/856,923 filed on Apr. 4, 2013.

As shown in FIGS. 2A and 2B, the nowcaster 200 receives weather observations from different sources 201 such as weather observations sources including but not limited to: point observations 201-2 (e.g. feedback provided by users and automated stations), weather radars 201-3, satellites 201-4 and other types of weather observations 201-1, and weather forecast sources such as numerical weather prediction (NWP) model output 201-5 and weather forecasts and advisories 201-6.

The nowcaster 200 comprises a memory 220 and a processor 210. The memory 220 comprises the instructions for the method and also stores data from the weather sources 201, intermediate results and weather forecasts. The processor 210 allows the nowcaster 200 to perform calculations.

The nowcaster 200 can receive information 230 from a user through a communication network 254. According to an embodiment, this information 230 may be the chosen time increment 100.

The nowcaster 200 outputs a weather forecast, or a succession of weather forecasts.

In an embodiment, the nowcaster 200 comprises a PType distribution forecaster 202 and a PRate distribution forecaster 204. The PType forecaster 202 receives the weather observations from the different sources 201 and outputs a probability distribution of precipitation type over an interval of time, for a given latitude and longitude (and/or location). For example:

a. Snow: 10%

b. Rain: 30%

c. Freezing Rain: 60%

d. Hail: 0%

e. Ice Pellets: 0%

Similarly, the PRate forecaster 204 receives the weather observations for a given latitude and longitude from the different sources 201 and outputs a probability distribution forecast of a precipitation rate (PRate) in a representation that expresses the uncertainty. For example, the PRate may be output as a probability distribution of precipitation rates or a range of rates over an interval of time, for a given latitude and longitude. For example:

f. No Precip: 30%

g. Light: 40%

h. Moderate: 20%

i. Heavy: 10%

The PRate and PType values output by the PRate forecaster 204 and the PType forecaster 202 are sent to a forecast combiner 206 to combine these values into a single value PTypeRate which represents the precipitation outcomes. For example, if the value of PType is “Snow”, and the value of “PRate” is heavy, the combined value of PTypeRate may be “heavy snow”.

For a given latitude and longitude, the system outputs forecasted PTypeRate Distributions for predefined time intervals, either fixed (ex: 1 minute) or variable (ex: 1 minute, then 5 minutes, then 10 minutes, etc). The system can either pre-calculate and store forecasted PTypeRate Distributions in a sequence of time intervals, or calculate it on the fly. A PTypeRate Distribution represents, for each time interval, the certainty or uncertainty that a PTypeRate will occur.

With reference to FIG. 2B, the forecast combiner 206 receives the final PRate distribution from the PType forecaster 202 and the final PRate distribution from the PRate forecaster 204 to combine them into a group of PTypeRate distribution values each representing the probability of receiving a certain type of precipitation at a certain rate. An example is provided below.

Assuming that the PType distribution is as follows: Snow: 50%, Rain 0%, Freezing rain: 30%, Hail 0%, Ice pellets 20%, and the PRate distribution is as follows: None: 0%, light: 10%, moderate:20%, Heavy: 30%, Very heavy 40%, the PTypeRate distributions may be as follows:

| | PType | | | | |
|---|---|---|---|---|---|
| | Snow | Rain | Freez. Rain | Hail | Ice Pellets |
| PRate | 50% | 0% | 30% | 0% | 20% |
| None 0% | No | No | No | No | No |
| | precipitation | precipitation | precipitation | precipitation | precipitation |
| Light | 5% light | No | 3% light | No | 2% light ice |
| 10% | snow | precipitation | freezing rain | precipitation | pellets |
| Moderate | 10% | No | 6% | No | 4% |
| 20% | moderate | precipitation | moderate | precipitation | moderate |
| | snow | | freezing rain | | ice pellets |
| Heavy | 15% heavy | No | 9% heavy | No | 6% heavy |
| 30% | snow | precipitation | freezing rain | precipitation | ice pellets |
| V. heavy | 20% heavy | No | 12% v. heavy | No | 8% v. heavy |
| 40% | snow | precipitation | freezing rain | precipitation | ice pellets |

Accordingly, the forecast combiner 206 multiplies the probability of each type of precipitation by the probability of each rate of precipitation to obtain a probability of receiving a certain type of precipitation at a certain rate for example, 20% chance of heavy snow, or 12% chance of very heavy freezing rain. In an embodiment, it is possible to associate probability ranges with textual information for displaying the textual information to the user instead of the probabilities in numbers. For example, probabilities that are between 5% and 15% may be associated with the text: “low chance”, while probabilities that are between 40% and 70% may be associated with the text “high chance”, or “very likely” etc. whereby, instead of displaying: 60% chance of heavy snow, it is possible to display: “high chance of heavy snow”.

In another embodiment, it is possible to combine two or more different PTypeRates along one or more dimensions (the dimensions including: the rate, type, or probability). For example, results of such combination may include: Likely light to moderate rain, Likely light to moderate rain or heavy snow; Likely moderate rain or snow; likely rain or snow; chance of light to moderate rain or heavy snow or light hail; chance of moderate rain, snow or hail; chance of rain, snow or hail, etc.

Accordingly, the nowcaster 200 receives the location for which the nowcasts are needed and the time and/or time interval for which the nowcasts are needed and outputs the PTypeRate distribution for the given location and for the specific time.

There may be another embodiment of the nowcaster 200. In this embodiment, the nowcaster comprises a PType selector/receiver and a PRate distribution forecaster. Similar to the embodiment shown in FIG. 2B, the PRate distribution forecaster receives the weather observations for a given latitude and longitude from the different sources and outputs a probability distribution forecast of a precipitation rate (PRate) in a representation that expresses the uncertainty. For example, the PRate may be output as a probability distribution of precipitation rates or a range of rates over an interval of time, for a given latitude and longitude. For example:

f. No Precip.: 30%

g. Light: 40%

h. Moderate: 20%

i. Heavy: 10%

However, the PType selector/receiver does not output a probability distribution associated with different types of precipitation. Instead, the PType selector/receiver receives weather observations for a given latitude and longitude from the different sources to select one precipitation type from a list of different precipitation types. For example, based on the inputs received from the sources, the PType selector/receiver selects a single precipitation type that is most likely to occur in the given latitude and longitude (and/or location) from the following list of precipitation types:

a. Snow

b. Rain

c. Freezing Rain

d. Hail

e. Ice Pellets

f. Mix (e.g., a+c, a+d, b+c, a+e, c+e, d+e, etc.)

From the list of precipitation types such as the one above, only one precipitation type is selected for a given location. For example, a mix of snow and freezing rain can be selected as the most likely precipitation type for a given location at a given time. The precipitation type is not associated with a probability value. In fact, since only one precipitation type is selected for any given location and time corresponding to the location, the selected precipitation type will have the effective probability value of 100%.

The list of precipitation types that are available for selection of one type may include a mix type that represents a mix of two different precipitation types (e.g., snow and freezing rain, hail and ice pellets, etc.). A mix type is considered as a distinct precipitation type available for selection and, as shown above in (f) of the list, there can be many different mix types representing the mix of different pairs of various precipitation types.

In another embodiment, the precipitation type is not selected by the PType selector/receiver but instead is received from a source outside the nowcaster. In other words, the nowcaster 200 may request to a remote source (e.g., a third-party weather service) identification of the precipitation type that is most likely to occur for a given location at a given time and receive a response from the source identifying the most likely precipitation type. In this case, selection of the precipitation type is not performed by the nowcaster. The nowcaster merely is inputted with the already-selected precipitation type and thereby can save computational power of the nowcaster that would otherwise have been needed to perform the selection.

The selected precipitation type and the PRate values respectively output by the PType selector/receiver and the PRate distribution forecaster are combined. For example, if the selected precipitation type is snow, and the PRate values are as described above, the combined information would indicate:

a. No Snow: 30%

b. Light Snow: 40%

c. Moderate Snow: 20%

d. Heavy Snow: 10%.

As only one precipitation type is concerned, only minimal amount of computational power is needed to perform the combining to output the final weather forecast data. Since the PType selector/receiver will output one (1) precipitation type for a given location and time, if the PRate distribution forecaster outputs a number m of probability distribution, the final weather forecast data will comprise only a number m (m*1) of weather forecast distribution.

In outputting the final weather forecast data, it is possible to associate probability ranges with textual information for displaying the textual information to the user instead of the probabilities in numbers, similar to the embodiment shown in FIG. 2B. For example, probabilities that are between 5% and 15% may be associated with the text: “low chance,” while probabilities that are between 40% and 70% may be associated with the text “high chance,” or “very likely,” etc. whereby, instead of displaying: “60% chance of heavy snow,” it is possible to display: “high chance of heavy snow.”

Accordingly, the nowcaster receives the location for which the nowcasts are needed and the time and/or time interval for which the nowcasts are needed and outputs the selected PType and PRate distribution for the given location and for the specific time.

The nowcaster according to this another embodiment may be advantageous over the embodiment shown in FIG. 2B in certain circumstances in which efficiency is desired. This another embodiment can be implemented using much less processing power than the embodiment of FIG. 2B. However, the embodiment of FIG. 2B may be more suitable than this another embodiment in providing more detailed and accurate snapshot of weather forecast data for any given location and time.

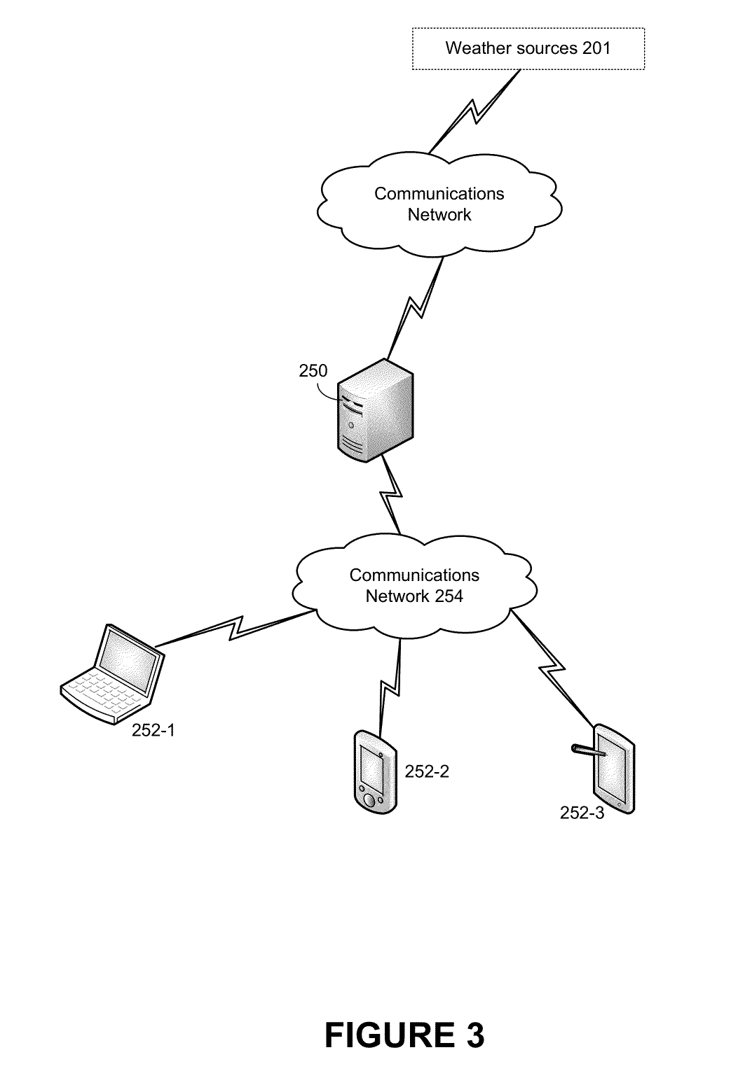

FIG. 3 is an example of a network environment in which the embodiments may be practiced. The nowcaster 200 may be implemented on a server 250 which is accessible by a plurality of client computers 252 over a communication network 254. The client computers 252 may include but not limited to: laptops, desktops, portable computing devices, tablets and the like. Using a client computer 252, each user may select the chosen time increment 100 and view the displayed forecasted weather values. The server accesses weather source 201 over a telecommunications network as discussed in connection with FIG. 2B. The server 250 may have map data stored thereon.

According to an embodiment, the client computers 252 may be used for localization to provide weather forecasts for an appropriate given territory, which can be the current location of the user. This localization may occur through a computing device which is enabled for localization or through a GPS navigation device.

The client computer 252 should comprise a user interface, such as a screen, to allow the output 140 of the weather forecast. On the user interface, the user is able to choose a time increment 100.

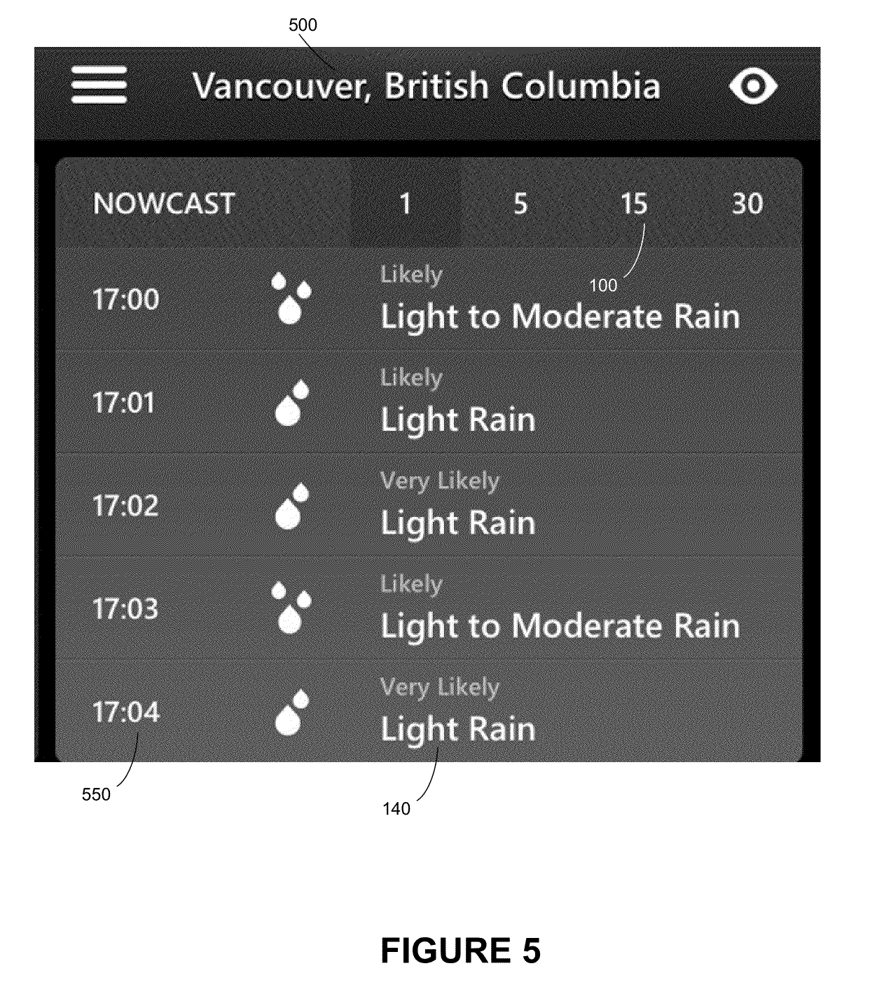

FIG. 5 is a screenshot of a user interface illustrating the presenting 150 of a succession weather forecasts displayed with a default one-minute time increment according to an embodiment. The highlighted number illustrates the time increment 100 that has been chosen by the user. Since the number one is highlighted, the weather forecast displayed in FIG. 5 (“no rain” in this example) is displayed with a one-minute time increment. The succession of weather forecasts is related to location 500 and times 550.

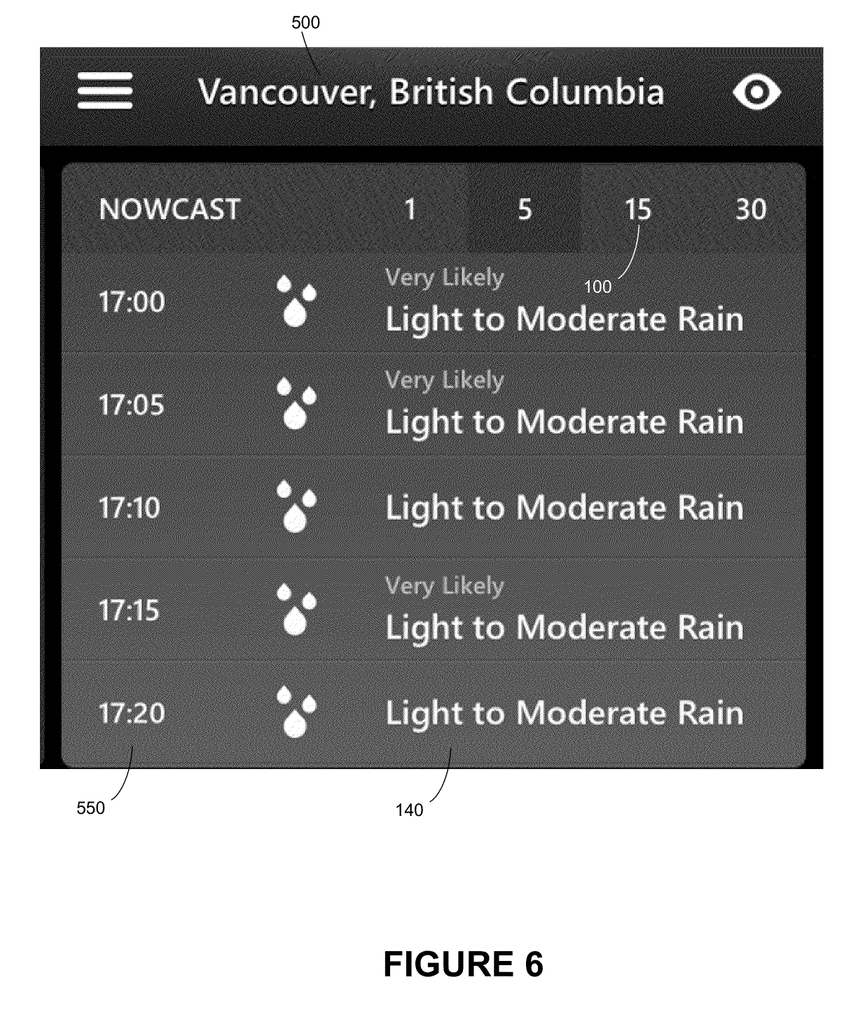

FIG. 6 is a screenshot of a user interface illustrating an output 140 of a succession weather forecasts displayed with a five-minute time increment according to an embodiment. As in FIG. 5, the highlighted number illustrates the time increment 100 that has been chosen by the user. Since the number five is highlighted, the weather forecast displayed in FIG. 6 (“no rain” in this example) is displayed with a five-minute time increment. The succession of weather forecasts is related to location 500 and times 550.

### Hardware and Operating Environment

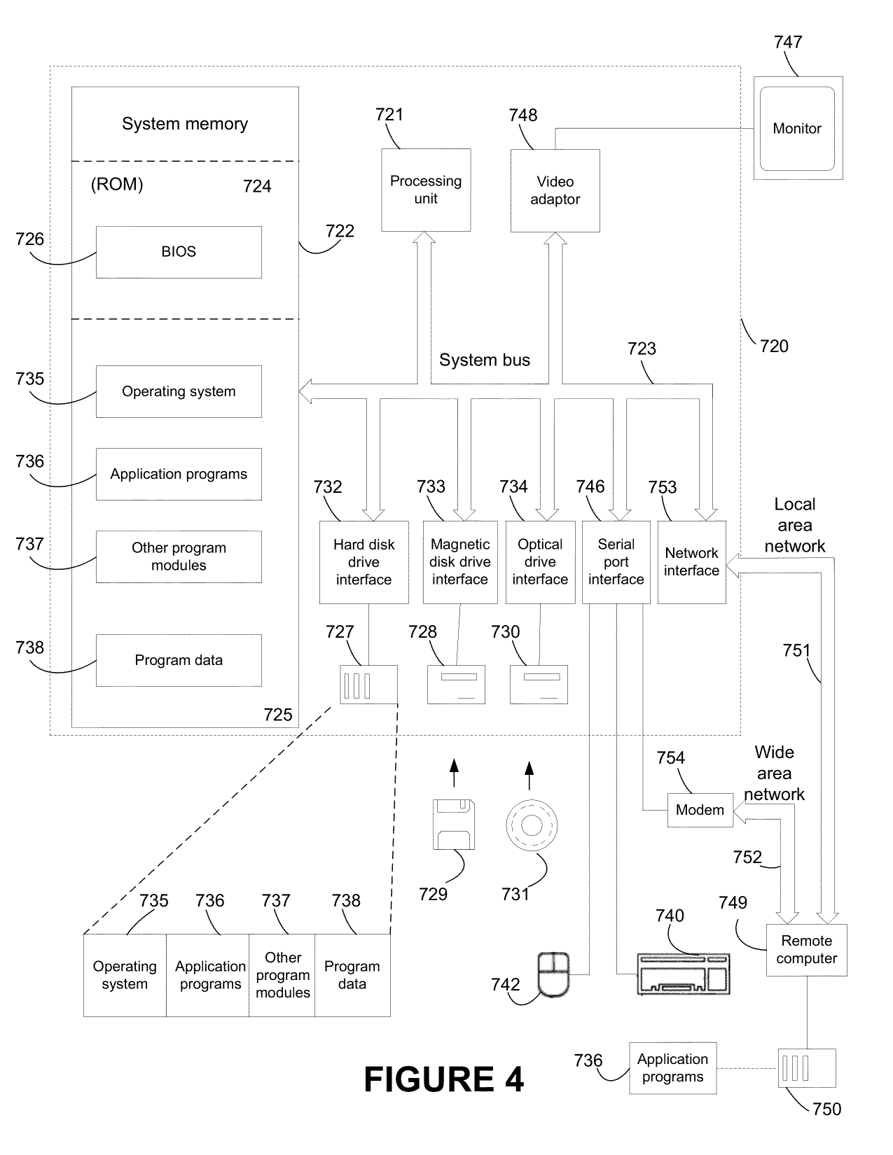

FIG. 4 illustrates an exemplary diagram of a suitable computing operating environment in which embodiments of the invention may be practiced. The following description is associated with FIG. 4 and is intended to provide a brief, general description of suitable computer hardware and a suitable computing environment in conjunction with which the embodiments may be implemented. Not all the components are required to practice the embodiments, and variations in the arrangement and type of the components may be made without departing from the spirit or scope of the embodiments.

Although not required, the embodiments are described in the general context of computer-executable instructions, such as program modules, being executed by a computer, such as a personal computer, a hand-held or palm-size computer, Smartphone, or an embedded system such as a computer in a consumer device or specialized industrial controller. Generally, program modules include routines, programs, objects, components, data structures, etc., that perform particular tasks or implement particular abstract data types.

Moreover, those skilled in the art will appreciate that the embodiments may be practiced with other computer system configurations, including hand-held devices, multiprocessor systems, microprocessor-based or programmable consumer electronics, network PCS, minicomputers, mainframe computers, cellular telephones, smart phones, display pagers, radio frequency (RF) devices, infrared (IR) devices, Personal Digital Assistants (PDAs), laptop computers, wearable computers, tablet computers, a device of the IPOD or IPAD family of devices manufactured by Apple Computer, integrated devices combining one or more of the preceding devices, or any other computing device capable of performing the methods and systems described herein. The embodiments may also be practiced in distributed computing environments where tasks are performed by remote processing devices that are linked through a communications network. In a distributed computing environment, program modules may be located in both local and remote memory storage devices.

The exemplary hardware and operating environment of FIG. 4 includes a general purpose computing device in the form of a computer 720, including a processing unit 721, a system memory 722, and a system bus 723 that operatively couples various system components including the system memory to the processing unit 721. There may be only one or there may be more than one processing unit 721, such that the processor of computer 720 comprises a single central-processing unit (CPU), or a plurality of processing units, commonly referred to as a parallel processing environment. The computer 720 may be a conventional computer, a distributed computer, or any other type of computer; the embodiments are not so limited.

The system bus 723 may be any of several types of bus structures including a memory bus or memory controller, a peripheral bus, and a local bus using any of a variety of bus architectures. The system memory may also be referred to as simply the memory, and includes read only memory (ROM) 724 and random access memory (RAM) 725. A basic input/output system (BIOS) 726, containing the basic routines that help to transfer information between elements within the computer 720, such as during start-up, is stored in ROM 724. In one embodiment of the invention, the computer 720 further includes a hard disk drive 727 for reading from and writing to a hard disk, not shown, a magnetic disk drive 728 for reading from or writing to a removable magnetic disk 729, and an optical disk drive 730 for reading from or writing to a removable optical disk 731 such as a CD ROM or other optical media. In alternative embodiments of the invention, the functionality provided by the hard disk drive 727, magnetic disk 729 and optical disk drive 730 is emulated using volatile or non-volatile RAM in order to conserve power and reduce the size of the system. In these alternative embodiments, the RAM may be fixed in the computer system, or it may be a removable RAM device, such as a Compact Flash memory card.

In an embodiment of the invention, the hard disk drive 727, magnetic disk drive 728, and optical disk drive 730 are connected to the system bus 723 by a hard disk drive interface 732, a magnetic disk drive interface 733, and an optical disk drive interface 734, respectively. The drives and their associated computer-readable media provide nonvolatile storage of computer-readable instructions, data structures, program modules and other data for the computer 720. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 729, optical disk 731, ROM 724, or RAM 725, including an operating system 735, one or more application programs 736, other program modules 737, and program data 738. A user may enter commands and information into the personal computer 720 through input devices such as a keyboard 740 and pointing device 742. Other input devices (not shown) may include a microphone, joystick, game pad, satellite dish, scanner, touch sensitive pad, or the like. These and other input devices are often connected to the processing unit 721 through a serial port interface 746 that is coupled to the system bus, but may be connected by other interfaces, such as a parallel port, game port, or a universal serial bus (USB). In addition, input to the system may be provided by a microphone to receive audio input.

A monitor 747 or other type of display device is also connected to the system bus 723 via an interface, such as a video adapter 748. In one embodiment of the invention, the monitor comprises a Liquid Crystal Display (LCD). In addition to the monitor, computers typically include other peripheral output devices (not shown), such as speakers and printers. The monitor may include a touch sensitive surface which allows the user to interface with the computer by pressing on or touching the surface.

The computer 720 may operate in a networked environment using logical connections to one or more remote computers, such as a remote computer 749. These logical connections are achieved by a communication device coupled to or a part of the computer 720; the embodiment is not limited to a particular type of communications device. The remote computer 749 may be another computer, a server, a router, a network PC, a client, a peer device or other common network node, and typically includes many or all of the elements described above relative to the computer 720, although only a memory storage device 750 has been illustrated in FIG. 6. The logical connections depicted in FIG. 6 include a local-area network (LAN) 751 and a wide-area network (WAN) 752. Such networking environments are commonplace in offices, enterprise-wide computer networks, intranets and the Internet.

When used in a LAN-networking environment, the computer 720 is connected to the local network 751 through a network interface or adapter 753, which is one type of communications device. When used in a WAN-networking environment, the computer 720 typically includes a modem 754, a type of communications device, or any other type of communications device for establishing communications over the wide area network 752, such as the Internet. The modem 754, which may be internal or external, is connected to the system bus 723 via the serial port interface 746. In a networked environment, program modules depicted relative to the personal computer 720, or portions thereof, may be stored in the remote memory storage device. It is appreciated that the network connections shown are exemplary and other means of and communications devices for establishing a communications link between the computers may be used.

The hardware and operating environment in conjunction with which embodiments of the invention may be practiced has been described. The computer in conjunction with which embodiments of the invention may be practiced may be a conventional computer a hand-held or palm-size computer, a computer in an embedded system, a distributed computer, or any other type of computer; the invention is not so limited. Such a computer typically includes one or more processing units as its processor, and a computer-readable medium such as a memory. The computer may also include a communications device such as a network adapter or a modem, so that it is able to communicatively couple other computers.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A computer implemented method for outputting a chronological succession of weather forecasts starting at a given time, over a given period, and for a given territory, the method comprising:
receiving forecasted weather values prepared by a weather value forecaster, the forecasted weather values starting at the given time and for subsequent times separated by a default time increment;
receiving a choice of a time increment from a user, the chosen time increment defining a succession of specific times starting at the given time and for subsequent times separated by the chosen time increment, the chosen time increment being smaller than 1 hour;
for the choice of a time increment, using the forecasted weather values at the default time increment for generating a new succession of weather forecasts for time intervals between the specific times; and
outputting the succession of weather forecasts for the time intervals between the specific times.

2. The method of claim 1, wherein receiving the forecasted weather values comprises receiving forecasted weather values which comprise at least one of a precipitation rate, a precipitation type, a precipitation probability, a temperature, a pressure, a relative humidity, a wind velocity, a wind direction, a value relative to a lightning, a value relative to hail, and a value relative to a microburst.

3. The method of claim 2, wherein generating the succession of weather forecasts comprises using at least one of a precipitation rate, a precipitation type, a precipitation probability, a temperature, a pressure, a relative humidity, a wind velocity, a wind direction, a value relative to a lightning, a value relative to hail, and a value relative to a microburst among the forecasted weather values.

4. The method of claim 3, wherein generating the succession of weather forecasts for the time intervals between the specific times comprises selecting among the forecasted weather values prepared at the default time increment at least one of the forecasted weather values prepared for each specific time.

5. The method of claim 3, wherein generating the succession of weather forecasts for the time intervals between the specific times comprises averaging weather values prepared for times that are within a time range which includes each specific time and selected among the forecasted weather values prepared at the default time increment.

6. The method of claim 1, wherein outputting the succession of weather forecasts comprises presenting the succession of weather forecasts to the user.

7. The method of claim 1, wherein outputting the succession of weather forecasts comprises outputting the succession of weather forecasts over a given period smaller than 6 hours.

8. The method of claim 1, wherein receiving a choice of a time increment comprises receiving a time increment saved from a previous use.

9. The method of claim 1, wherein generating the succession of weather forecasts at the chosen time increment comprises generating the succession of weather forecasts at a chosen time increment of 1 minute, 5 minutes, 15 minutes or 30 minutes.

10. The method of claim 1, wherein receiving a choice of a time increment comprises receiving a choice of a time increment which is variable over the given period.

11. The method of claim 1, wherein generating the succession of weather forecasts starting at the given time comprises generating the succession of weather forecasts starting at a current time.

12. The method of claim 1, wherein outputting a succession of weather forecasts for a given territory comprises outputting a succession of weather forecasts for a very small region defined as having a resolution ranging between 5 meters and 1,000 meters.

13. The method of claim 12, wherein outputting a succession of weather forecasts for a very small region comprises outputting a succession of weather forecasts for a current location of the user.

14. The method of claim 13, wherein outputting a succession of weather forecasts for a current location of the user comprises outputting a succession of weather forecasts for a current location which is determined through a computing device which is enabled for localization by a communication network or through a GPS navigation device.

15. The method of claim 1, wherein receiving a choice of a time increment from a user comprises receiving any real number specified by the user.

16. The method of claim 1, wherein receiving a choice of a time increment from a user comprises receiving the chosen time increment which is greater than or equal to the default time increment.

17. A system for outputting a chronological succession of weather forecasts starting at a given time, over a given period, and for a given territory, the system comprising:
an input for receiving forecasted weather values prepared by a weather value forecaster, the forecasted weather values starting at the given time and for subsequent times separated by a default time increment;
an input for receiving a choice of a time increment from a user, the chosen time increment defining a succession of specific times starting at the given time and for subsequent times separated by the chosen time increment, the chosen time increment being smaller than 1 hour;
a weather forecast generator for generating, for each choice of a time increment, a new succession of weather forecasts for time intervals between the specific times using the forecasted weather values; and
an output for outputting the succession of weather forecasts for the time intervals between the specific times.

18. A device for outputting a chronological succession of weather forecasts starting at a given time, over a given period, and for a given territory, the device comprising:
one or more processors;
a memory storing instructions for the one or more processors, wherein when the instructions are executed by the one or more processors, the device is caused to:
receive forecasted weather values prepared by a weather value forecaster, the forecasted weather values starting at the given time and for subsequent times separated by a default time increment;
receive a choice of a time increment from a user, the chosen time increment defining a succession of specific times starting at the given time and for subsequent times separated by the chosen time increment, the chosen time increment being smaller than 1 hour;
for each choice of a time increment, use the forecasted weather values at the default time increment for generating a new succession of weather forecasts for time intervals between the specific times; and
output the succession of weather forecasts for the time intervals between the specific times.

19. A non-transitory computer-readable medium comprising instructions of claim 1.
